(19) United States
(12) Patent Application Publication
(10) Pub. No.: US 2009/0101571 A1
(43) Pub. Date: Apr. 23, 2009

(54) Drilling fluids settling tank

(76) Inventor: Melvin D. Kapicki, Leduc (CA)

Correspondence Address: FLYNN THIEL BOUTELL & TANIS, P.C., 2026 RAMBLING ROAD, KALAMAZOO, MI, 49008-1631, US

(21) Appl. No.: 11/975,682

(22) Filed: Oct. 19, 2007

(51) Int. Cl. B01D 21/24

(52) U.S. Cl. 210/523; 210/803

(57) ABSTRACT

A settling tank for drilling fluids is provided, having a first compartment. The first compartment has confining walls, an inlet, an outlet weir, and a source of secondary fluid. At least one of the confining walls has a downwardly sloped confining wall. The inlet is provided for supply of drilling fluids into the first compartment. The outlet weir is positioned in at least one of the confining walls. At least one source of secondary fluid is provided. The source of secondary fluid is configured to direct fluids down the downwardly sloped confining wall towards a collection area. By directing fluids down the downwardly sloped confining wall, solids that may accumulate in the compartment are more efficiently moved towards the collection area where they can be removed. The apparatus and method disclosed herein describe an efficient approach to processing drilling fluids on site.

### FIELD AND BACKGROUND

The device and method described here are related to the field of settling tanks used for processing of drilling fluids in the oil and gas industry. Many such settling tanks are known. For example, CA 2,485,875 describes a settling tank and method for separating a solids containing fluid. A challenge in the industry is to provide tanks with efficient processing of the fluids.

### SUMMARY

In one embodiment, a settling tank for drilling fluids is provided, comprising a first compartment. The first compartment comprises confining walls, an inlet, an outlet weir, and a source of secondary fluid. At least one of the confining walls comprises a downwardly sloped confining wall. The inlet is provided for supply of drilling fluids into the first compartment. The outlet weir is positioned in at least one of the confining walls. At least one source of secondary fluid is provided. The source of secondary fluid is configured to direct fluids down the downwardly sloped confining wall towards a collection area. Multiple compartments may be provided.

In another embodiment, a method is provided for settling drilling fluids in a tank. Drilling fluids are supplied into a first compartment. The first compartment comprises confining walls including at least one downwardly sloped confining wall. Secondary fluid is supplied into the first compartment to direct fluids down the downwardly sloped confining wall towards a collection area. Fluids are removed from the compartment over an outlet weir, and may be processed in a further series of compartments.

### BRIEF DESCRIPTION OF THE FIGURES

Embodiments will now be described with reference to the figures, in which like reference characters denote like elements, by way of example, and in which:

FIG. 1 is a top plan view of a settling tank for drilling fluids.

FIG. 2 is a side elevation view, partially in section, of the settling tank from FIG. 1.

FIG. 3 is a flow diagram of a method of settling drilling fluids in a tank.

FIG. 4 is a flow diagram of a method of settling drilling fluids in a tank and removing settled materials from the compartment.

FIG. 5 is a flow diagram of a method of settling drilling fluids in a tank with multiple compartments.

FIG. 6 is a flow diagram of a further method of settling drilling fluids in a tank with multiple compartments.

### DESCRIPTION

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims. Immaterial modifications may be made to the embodiments described here without departing from what is covered by the claims.

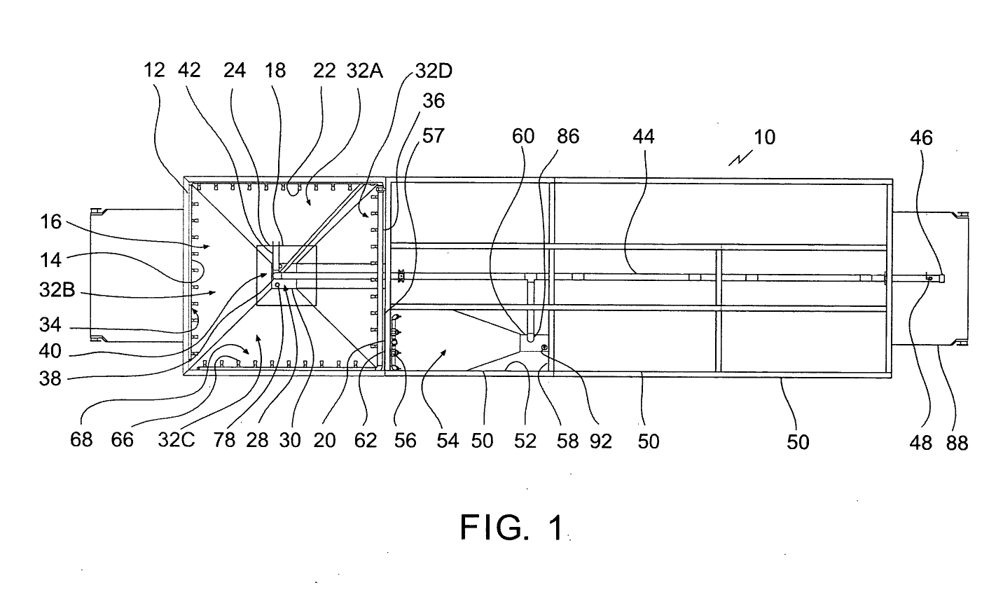

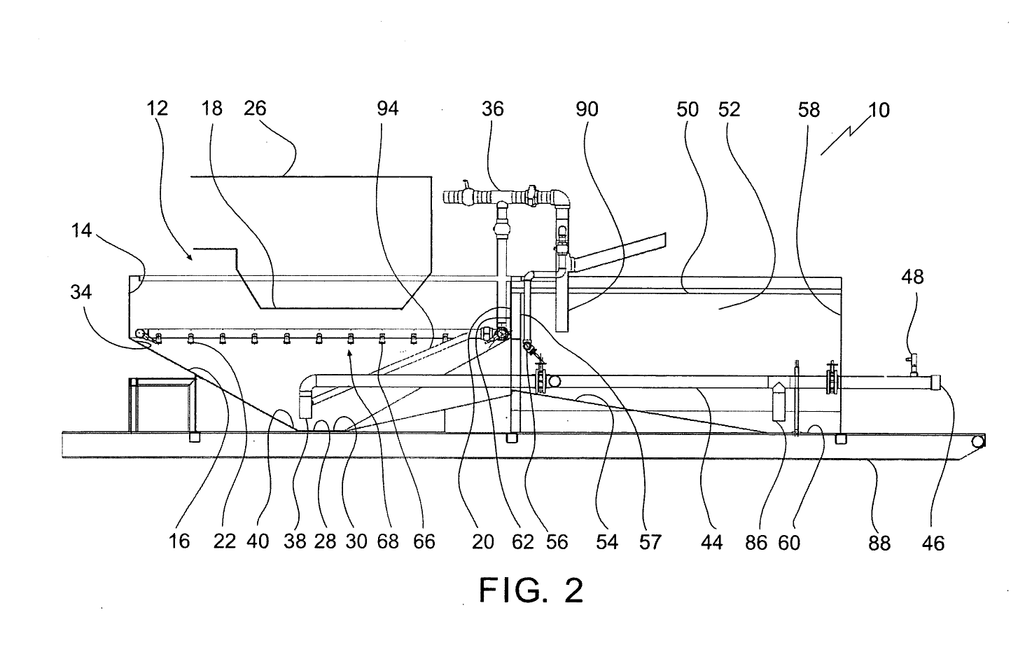

Referring to FIG. 1, a settling tank 10 for drilling fluids is illustrated comprising at least a first compartment 12. First compartment 12 comprises confining walls 14, an inlet 18, an outlet weir 20, and a source of secondary fluid 22. Inlet 18 is configured for supply of drilling fluids into first compartment 12. In some embodiments, inlet 18 may be configured to supply drilling fluids into first compartment 12 in a downward direction. A downward direction may comprise any direction with a downward directional component. Referring to FIG. 1, in one embodiment of settling tank 10, inlet 18 may comprise a hopper 24 situated above the compartment 12 at a height suitable to receive drilling fluids. Referring to FIG. 2, in another embodiment of settling tank 10, inlet 18 may comprise an elbow 26 into the open end of which drilling fluids are supplied. Alternatively, any type of suitable inlet 18 may be provided, including for example, a pipe or conduit. Referring to FIG. 1, inlet 18 may be positioned over a collection area 28.

Referring to FIGS. 1 and 2, confining walls 14 contain any fluid deposited within first compartment 12. At least one of confining walls 14 may be a downwardly sloped confining wall 16. Downwardly sloped confining wall 16 forms at least part of a bottom 30 of first compartment 12. Collection area 12 may be in a depression formed in bottom 30 of first compartment 12. The depression may form a sump. In the embodiment shown in FIG. 1, downwardly sloped confining wall 16 comprises at least four flat areas 32A, 32B, 32C, and 32D sloped towards collection area 28. Alternatively, downwardly sloped confining wall 16 may comprise a number of flat areas. In addition, downwardly sloped confining wall 16 may comprise flat or arcuate areas. Alternatively, other shapes of downwardly sloped confining wall 16 are possible.

Referring to FIG. 2, outlet weir 20 is located in at least one of confining walls 14. outlet weir 20 may be any type of weir used in the settling tank industry. A standard weir comprises a lowered wall over which fluids spill overtop of. Outlet weir 20 may be used for draining fluids from first compartment 12, whenever the level of fluids in first compartment 12 rises above outlet weir 20. In order for outlet weir 20 to properly drain fluids from first compartment 12, outlet weir 20 must be lower than the other confining walls 14.

Referring to FIG. 2, at least one source of secondary fluid 22 is configured to direct fluids down downwardly sloped confining wall 16 towards collection area 28. In the embodiment shown in FIGS. 1 and 2, there is provided more than one source of secondary fluid 22. Referring to FIG. 2, source of secondary fluid 22 is positioned over an upper end 34 of downwardly sloped confining wall 16. Source of secondary fluid 22 may be connected to a pipe manifold 36 that supplies secondary fluid to source of secondary fluid 22. Pipe manifold 36 may be connected to supply secondary fluid to more than one source of secondary fluid 22 as illustrated in FIGS. 1 and 2. In some embodiments of settling tank 10, there are more than one source of secondary fluid 22 distributed around downwardly sloped confining wall 16. In other embodiments, source of secondary fluid 22 surrounds collection area 28. Referring to FIG. 1, sources of secondary fluid 22 supply secondary fluid down each of downwardly sloped confining walls 16. Source of secondary fluid 22 may comprises plural nozzles 66 arranged in an array 68. Source of secondary fluid 22 may supply fresh fluids, recycled fluids, or fluids processed within settling tank 10. Sources of secondary fluid 22 may be individually controllable, in order to adjust the direction of flow, fluid pressure and fluid flow rate of secondary fluid supplied. Referring to FIG. 2, some extending sources of secondary fluid 94 may extend deep within first compartment 12 to ensure that settled material does not get stuck in collection area 28.

Referring to FIGS. 1 and 2, in some embodiments first compartment 12 further comprises at least an outlet 38 configured to remove settled materials. Settled materials may include solids. Outlet 38 may be positioned at or near a lower end 40 of downwardly sloped confining wall 16. Outlet 38 may also be positioned at collection area 28. Outlet 38 may be configured to remove settled materials by attachment to one or more of a pump, a vacuum truck, or a centrifuge. Alternatively, other types of suction sources may be employed to achieve the same result. In the embodiment shown in FIG. 1, a pipe 42 connects outlet 38 to a centrifuge (not shown). In addition, a second pipe 44 is connected to outlet 38. Pipe 44 has a suction end 46 that may be attached to a vacuum truck (not shown). Alternatively, suction end 46 may be attached to a pump (not shown). An adjustable valve 48 may be positioned at suction end 46 of pipe 44, in order to fluidly connect/disconnect pipe 44 with a suction source. In addition, an adjustable valve (not shown) may be employed on pipe 42. In this manner, the type of suction source drawing settled materials through outlet 38 may be selectively adjusted.

Referring to FIG. 2, outlet weir 20 may be connected to supply fluid to a series of second compartments 50. Each second compartment 50 comprises confining walls 52, a further source of secondary fluid 56, and an inlet 57. Confining walls 52 may have an outlet weir 58 in at least one of confining walls 52. At least one of confining walls may comprise a downwardly sloped confining wall 54. Downwardly sloped confining wall 54 may be sloped towards a collection area 60. Source of secondary fluid 56 may be configured to direct fluids down downwardly sloped confining wall 54 towards collection area 60. It should be understood that each of second compartments 50 may have all the same components as first compartment 12 described above, although the second compartment inlets would normally be configured differently. Outlet weir 20 of first compartment 12 supplies fluid to second compartment 50. In turn, each outlet weir 58 of a preceding second compartment 50 supplies fluid to a subsequent second compartment 50. Each of outlet weirs 20 and 58 may be the same height. Outlet weirs 20 and 58 may be provided as slots in confining walls 14 and 52, respectively. Referring to FIG. 2, a gate 62 may be provided in between compartments 12 and 50, gate 62 providing a removable barrier between first compartment 12 and second compartment 50. In addition, gate 62 may be configured to fluidly disconnect inlet 57 of a subsequent compartment 50 from outlet weir 58 of a preceding second compartment 50 when in a closed position. Gate 62 may be provided in between any adjacent second compartments 50, in order to prevent fluids from entering one of the adjacent second compartments 50. Second compartments 50 may be provided in parallel, series, or both configurations. In the embodiment shown in FIG. 1, there are provided eight of second compartments 50. Each second compartment 50 may be a different size or shape than first compartment 12.

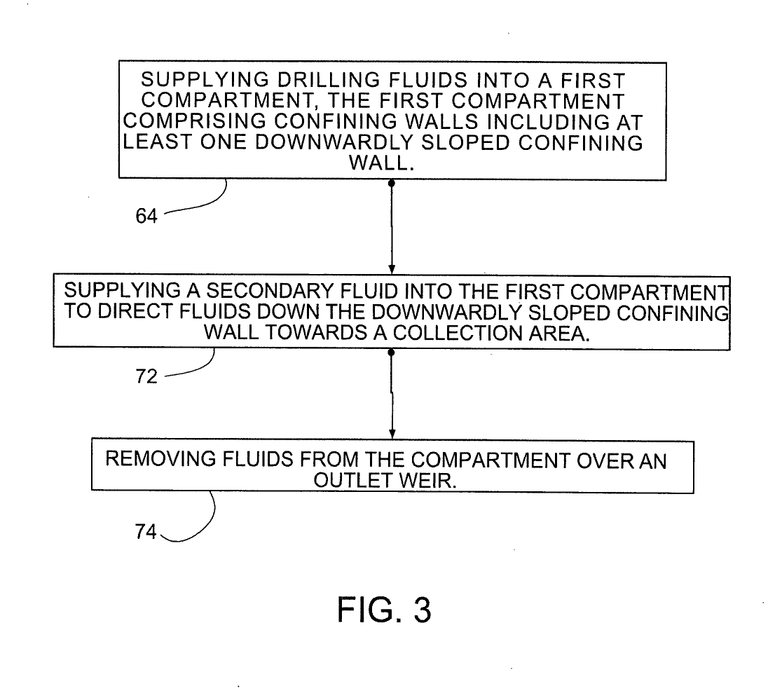

Referring to FIG. 3, a method for settling drilling fluids in a tank is illustrated. In step 64, drilling fluids are supplied to first compartment 12, first compartment 12 comprising confining walls 14 including at least one downwardly sloped confining wall 16. Referring to FIG. 2, drilling fluids may be directed downward into first compartment 12. Referring to FIGS. 1 and 2, drilling fluid may be supplied through either hopper 24 or elbow 26 located above collection area 28. Referring to FIG. 2, inlet 18 may be positioned within first compartment 12, in order to reduce the distance that drilling fluids introduced into first compartment 12 have to travel before reaching the fluid level. This ensures that drilling fluids that enter first compartment 12 will have less of an unsettling effect on any settled materials already contained within first compartment 12. Referring to FIG. 3, in step 72 a secondary fluid is supplied into first compartment 12 to direct fluids down downwardly sloped confining wall 16 towards collection area 28. Referring to FIG. 2, secondary fluid may be supplied from nozzles 66 surrounding collection area 28. Referring to FIG. 3, in step 74 fluids are removed from first compartment 12 over outlet weir 20. Referring to FIG. 2, fluids will drain over outlet weir 20 when they reach the height of outlet weir 20. Fluids contained near the surface will have the lowest amounts of unsettled solids, and thus it is preferred that outlet weir 20 be positioned near the top of first compartment 12. Alternatively, outlet weir 20 may be a slot (not shown) in one of confining walls 14. Fluids that are collected through outlet weir 20 may be reprocessed in first compartment 12 or reused.

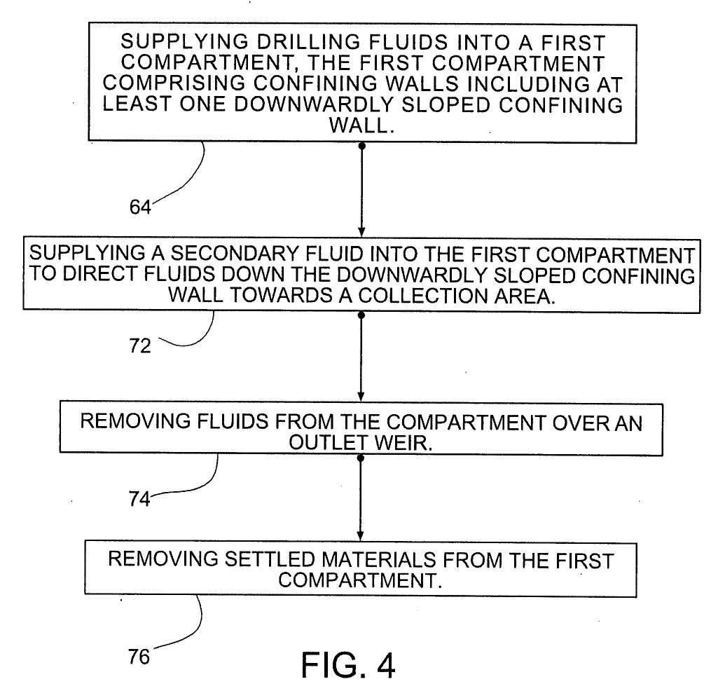

Referring to FIG. 4, another embodiment of the method of FIG. 3 is illustrated. In step 76, settled materials are removed from first compartment 12. Referring to FIG. 2, any materials capable of settling out of fluids contained within or supplied to first compartment 12 may build up over time in first compartment 12. These settled materials may be removed from collection area 28, through outlet 38. Additional outlets 38 may be supplied. An example of an additional outlet may be a drain 78. Settled materials may be removed by one or more of a pump, a vacuum truck, or a centrifuge, as previously described.

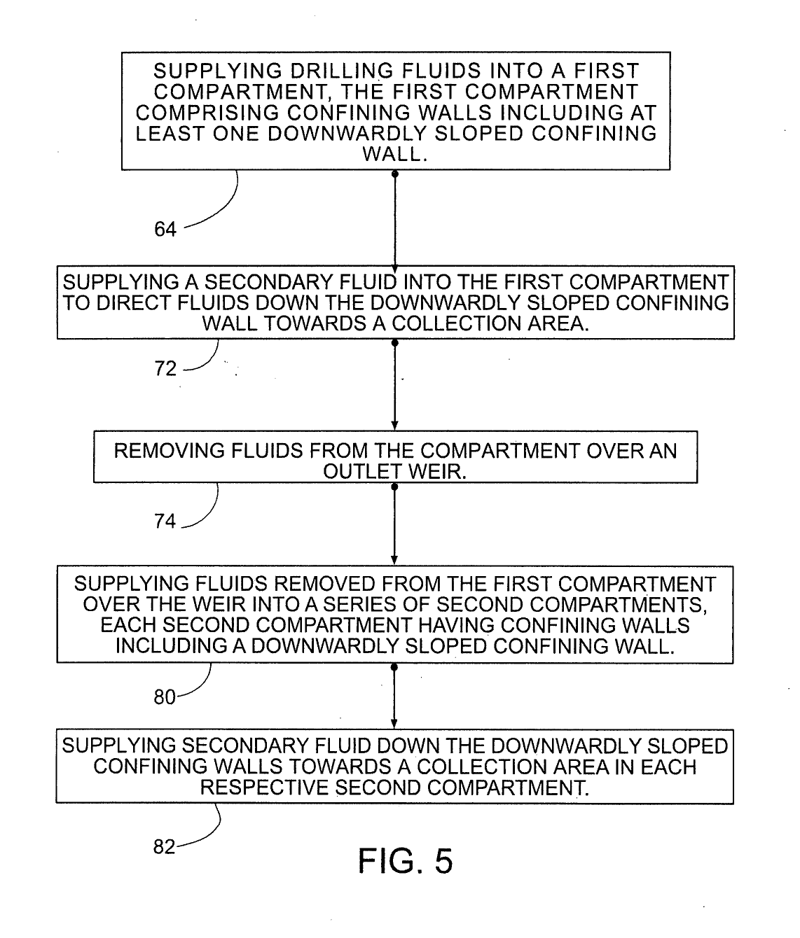

Referring to FIG. 5, another embodiment of the method of FIG. 3 is illustrated. In step 80, fluids removed from first compartment 12 over outlet weir 20 are supplied into a series of second compartments 50, each second compartment 50 having confining walls 52 including a downwardly sloped confining wall 54. Referring to FIG. 2, fluids spilling over outlet weir 20 pass into second compartment 50 for further settling. In turn, when a preceding second compartment 50 fills up to the level of its outlet weir 58, fluids will spill over outlet weir 58 and into a subsequent second compartment 50. Referring to FIG. 5, in step 82 secondary fluid is supplied down downwardly sloped confining walls 54 towards collection area 28 in each respective second compartment 50. Referring to FIG. 2, source of secondary fluid 56 is positioned adjacent outlet weir 20, in order to direct fluid flow down downwardly sloped confining walls 54. Source of secondary fluid 56 is positioned in this way in order to prevent the buildup of settled materials on downwardly sloped confining wall, and to ensure that any settled materials are directed down towards collection area 60 where they may be removed from second compartment 50. This is an efficient method of processing settled materials in settling tank 10.

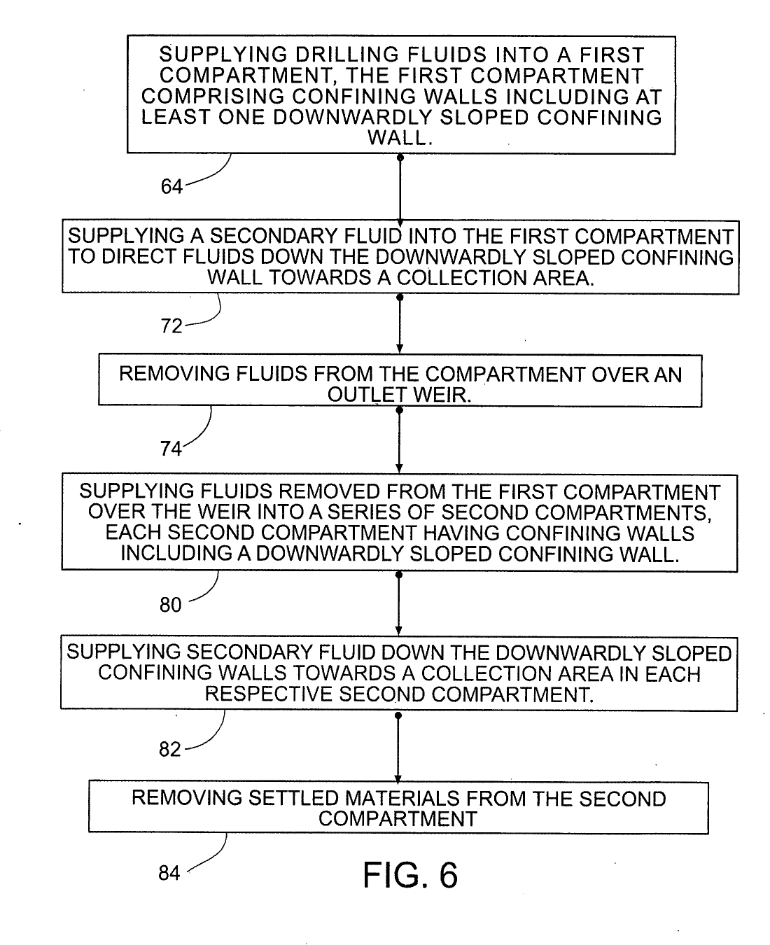

Referring to FIG. 6, a further embodiment of the method of FIG. 5 is illustrated. In step 84, settled materials are removed from second compartment 50. Referring to FIG. 1, this removal may be accomplished through an outlet 86. Outlet 86 may function in a similar manner as outlet 38, and may contain similar connectivity to pipes 42 and 44. In one embodiment, every outlet 86 of second compartments 50 are attached to the pipe 44 for removal of settled materials contained with each respective compartment 50. In addition, a drain 92 may be provided in second compartment 50 for removing settled materials, or fluids. Drain 92 may be located within collection area 60.

Referring to FIG. 2, settling tank 10 may be provided on a transportable skid 88. Transportable skid 88 may be transported to and from a job site. This portability affords great utility, as a remote job site may now be supplied with an efficient way of processing drilling fluids on site.

In addition, settling tank 10 may be configured to reuse fluids drawn from any of compartments 12 or 50 as secondary fluid. Referring to FIG. 2, in one embodiment, fluids may be drawn from second compartment 50 through a hose 90, the fluids being supplied to pipe manifold 36 and source of secondary fluid 22. In some embodiments, fluids drawn from a subsequent second compartment 50 may be used as secondary fluid in a preceding second compartment 50. In addition, any settled materials or fluids removed from outlets 86 of a subsequent second compartment 50 may be used as secondary fluid in a preceding second compartment 50.

In one embodiment, settling tank 10 is used to process drilling fluids comprising mainly water and solids. In some embodiments, settling tank 10 is used to process drilling mud. Drilling mud may typically contain drilling cuttings that must be separated out. In other embodiments, a flocculant may be added to settling tank 10.

What is claimed is:

1. A settling tank for drilling fluids comprising:
at least a first compartment comprising:
confining walls, at least one of the confining walls being a downwardly sloped confining wall;
an inlet for supply of drilling fluids into the first compartment;
an outlet weir in at least one of the confining walls; and
at least one source of secondary fluid configured to direct fluids down the downwardly sloped confining wall towards a collection area.

2. The settling tank of claim 1 wherein the first compartment further comprises at least an outlet configured to remove settled materials.

3. The settling tank of claim 2, wherein the at least an outlet is positioned at the collection area.

4. The settling tank of claim 1 wherein the at least one source of secondary fluid is positioned over an upper end of the downwardly sloped confining wall.

5. The settling tank of claim 1 wherein the source of secondary fluid comprises plural nozzles arranged in an array.

6. The settling tank of claim 2 wherein the at least an outlet is configured to remove settled materials by attachment to one or more of a pump, a vacuum truck, or a centrifuge.

7. The settling tank of claim 1 wherein the inlet is configured to supply drilling fluids into the first compartment in a downward direction.

8. The settling tank of claim 1 wherein the inlet comprises a hopper or elbow located over the collection area.

9. The settling tank of any one of claims 1-8 wherein the outlet weir is connected to supply fluid to a series of second compartments, each second compartment comprising:
confining walls including a downwardly sloped confining wall;
an outlet weir in at least one of the confining walls; and;
a further source of secondary fluid configured to direct fluids down the downwardly sloped confining wall towards a collection area

10. The settling tank of claim 9 further comprising a gate in the first compartment providing a removable barrier between the first compartment and a second compartment.

11. The settling tank of claim 1 wherein the downwardly sloped confining wall forms at least part of a bottom of the first compartment, and the collection area is in a depression formed in the bottom of the first compartment.

12. The settling tank of claim 1 wherein the source of secondary fluid surrounds the collection area.

13. The settling tank of claim 1 wherein the downwardly sloped confining wall comprises at least four flat areas sloped towards the collection area.

14. A method for settling drilling fluids in a tank comprising:
supplying drilling fluids into a first compartment, the first compartment comprising confining walls including at least one downwardly sloped confining wall;
supplying a secondary fluid into the first compartment to direct fluids down the downwardly sloped confining wall towards a collection area; and
removing fluids from the compartment over an outlet weir.

15. The method of claim 14 further comprising the step of:
removing settled materials from the first compartment.

16. The method of claim 15 wherein settled materials are removed from the collection area.

17. The method of claim 14 wherein secondary fluid is supplied from nozzles surrounding the collection area.

18. The method of claim 15 wherein settled materials are removed by one or more of a pump, a vacuum truck, or a centrifuge.

19. The method of claim 14 wherein the drilling fluid is directed downward into the first compartment.

20. The method of claim 14 wherein drilling fluid is supplied through a hopper or elbow located above the collection area.

21. The method of any one of claims 14-20 further comprising the steps of:
supplying fluids removed from the first compartment over the weir into a series of second compartments, each second compartment having confining walls including a downwardly sloped confining wall; and
supplying secondary fluid down the downwardly sloped confining walls towards a collection area in each respective second compartment.

22. The method of claim 24 further comprising the step of removing settled materials from the second compartment.
